(19) United States
(12) Patent Application Publication
(10) Pub. No.: US 2016/0260045 A1
(43) Pub. Date: Sep. 8, 2016

(54) EXECUTIVE COACHING SYSTEM

(71) Applicants: Tim Morin, Brooklyn, NY (US); Alison Eydenberg, Groton, MA (US)

(72) Inventors: Tim Morin, Brooklyn, NY (US); Alison Eydenberg, Groton, MA (US)

(21) Appl. No.: 15/061,724

(22) Filed: Mar. 4, 2016

Related U.S. Application Data
(60) Provisional application No. 62/128,193, filed on Mar. 4, 2015.

(51) Int. Cl. G06Q 10/06

(52) U.S. Cl. CPC G06Q 10/06398

(57) ABSTRACT

A method of providing real-time, ongoing, measurement of the results of executive coaching includes the steps of: providing a user interface through which a user identifies two or more developmental objectives, each developmental objective being associated with a behavioral reminder and a feedback statement; through the user interface, setting a reminder frequency to receive a notification of the behavioral reminder; through the user interface, receiving the behavioral reminder at the set reminder frequency; through the user interface, designating one or more reviewers to provide feedback regarding the developmental objectives; through the user interface, setting a feedback request frequency to provide an automated feedback request to the one or more reviewers; requesting feedback from the one or more reviewers at the set feedback request frequency using the feedback statement; and through the user interface, viewing the feedback from the one or more reviewers.

### BACKGROUND OF THE INVENTION

This application incorporates by reference and claims the benefit of priority to U.S. Provisional Application 62/128,193 filed on Mar. 4, 2015.

### BACKGROUND OF THE INVENTION

The present subject matter relates generally to an executive coaching system for helping executives reach personal and professional goals. More specifically, the present invention relates to an executive coaching system for real-time, ongoing measurement of the executive's progress against custom developmental goals using repeated feedback from co-workers who witness the executive at work, and for providing frequent, regular behavioral reminders to continuously reform habits and behaviors.

Executive coaching is designed to help facilitate the professional and personal development of business executives. Both vendors and consumers of executive coaching services have always struggled to measure and quantify the actual impact that coaching has on a client's (the person being coached) job effectiveness. Coaching is used to improve job effectiveness by impacting the client's leadership behaviors. Measuring how much actual behavior, as witnessed by the clients themselves and others (boss, coworkers, peers, reports, customers, etc.), has improved or worsened can be very tricky. And, further, it can be difficult to provide feedback at an appropriate time to make effective changes. Thus, there is a need for systems that provide “real time” feedback from the people working with the client regarding how they perceive the client's behavior change during and after the coaching.

Additionally, effective coaching requires helping executives make appropriate changes to behaviors and habits. Helping people overcome resistance to change in order to learn new habits/behavior can be very difficult, even with the help of a professional executive coach. The latest findings in neuroscience tell us that the human brain is malleable and changes with experience. According to this research, the key to breaking habits is to elicit attention and help people to hold this attention long enough to consolidate changes in the brain that correspond to desired changes in behavior. Continuous and repeated attention to the desired change strengthens the hard-wiring of newly created habits. The challenge with coaching as it is currently delivered, is that the coach is only there to provide behavioral reminders to the client periodically during coaching sessions or by email or phone calls.

Further, in order to measure whether or not the coaching has resulted in observable behavior change, coaches previously would typically conduct a 360-degree survey of the client's co-workers at the completion of the coaching engagement (typically six months). However, the timing of the survey was arbitrary in terms of the timeframe of the client's real behavior change. Also the survey results were shared with the client once and without further support since the formal coaching engagement had by that point ended. This was not very meaningful in terms of the client's continued development.

Also, in coaching and in executive development in general, “360-degree” feedback from an executive's boss, peers, reports and clients, etc. has previously been collected via live interviews or using online surveys. These were typically done once or twice during a coaching engagement (typically approximately six months) and initiated and administered by the client's company, the coach or the coaching company. The client did generally not initiate the surveys themselves. The results were normally only presented to the client by the coach in a scheduled feedback session. Depending on the company's confidentiality guidelines, the results were kept confidential with the individual and his/her coach, or shared with various stakeholders at the company.

And, previously, behavioral reminders in coaching were typically conveyed during actual coaching sessions between the coach and client or in an ad hoc basis by phone/email. These reminders typically stopped once the coaching has ended and the coach and client were no longer interacting.

There are previous attempts at providing executive coaching mobile applications on the market, but the functionality of these products is built around delivery of executive development “content” (articles, videos, etc.) covering broad categories of leadership development topics (“how to be an active listener”, etc.) or built around providing a “log” for self-reporting victories and setbacks in moving towards an individual's development goals. Some products attempted to provide “virtual” coaching, supplanting the role of a live coach, by answering questions or sending “tips of the day” type content. None of these products were designed to provide real-time, ongoing measurement of the client's progress against custom developmental goals (crafted by the client in partnership with their coach), using repeated feedback from co-workers who actually witness the client at work. Also, none of these products provided frequent, regular behavioral reminders (again, crafted by the client in partnership with their coach) directly to the client in an effort to rewire neural pathways and keep focus on development goals in between coaching and long after the coaching engagement has ended.

Accordingly, there is a need for an executive coaching system for real-time, ongoing measurement of the executive's progress against custom developmental goals using repeated feedback from co-workers who actually witness the client at work, and for providing frequent, regular behavioral reminders to continuously reform habits and behaviors, as described herein.

### BRIEF SUMMARY OF THE INVENTION

To meet the needs described above and others, the present disclosure provides an executive coaching system for real-time, ongoing measurement of the executive's progress against custom developmental goals using repeated feedback from co-workers who witness the client at work, and for providing frequent, regular behavioral reminders to continuously reform habits and behaviors. The executive coaching system may be provided as a mobile application that may be executed on a mobile device that interacts with network servers to accomplish the functionality described herein. And, although described in the context of use with executive clients, it is understood that the present invention may be used broadly in any coaching context and is not limited to executives. For example, the teachings herein are easily applied in the mentoring or other leadership skill building context.

The executive coaching system of the present disclosure offers a way to conveniently collect frequent “real time” feedback from the people working with the client regarding how they perceive the client's behavior change during and after the coaching.

Additionally, the executive coaching system of the present disclosure offers a way to deliver continuous and repeated (e.g., hourly, daily, weekly, etc.) customized (e.g., crafted by the coach and client specifically to reflect that client's developmental objectives) behavioral reminders to the client. These continuous reminders keep the client's attention on the desired behavior in between coaching sessions and beyond the end of the coaching engagement, thus keeping attention on these new behaviors even when the client is not speaking with his/her coach, and long after the coaching engagement has ended.

Regarding the behavioral reminder functionality, the executive coaching system “pings” the coaching client with behavioral reminders that have been custom designed by the client with his or her coach on the client's mobile device.

Accordingly, the described executive coaching system is a way to easily collect continuous, repeated, and ongoing feedback, as well as receive regular behavioral reminders to support this ongoing practice of desired behaviors.

In an embodiment, the executive coaching system is designed to be used by an executive receiving coaching (i.e., the user) from a professional executive coach. Critical inputs into the user's profile are created in partnership between the user/client and the coach. In this embodiment, the software application is not a retail product, but rather is provided by the executive coach. However, it is contemplated the systems and methods taught herein can be provided in any context.

In an embodiment, unlike traditional 360-degree feedback processes, the client controls the timing and frequency of the feedback collection. For example, a client may want immediate feedback on his or her performance regarding a presentation he or she just made to the staff. The executive coaching system allows the client to choose to survey select co-workers with a custom feedback statement (e.g., John delegates work appropriately.) regarding the client's performance. The selected co-workers rate the statement on a 1-10 scale (i.e., strongly disagree to strongly agree). The results of the survey may be restricted to only go to the client, who can see how he or she is progressing over time vis-à-vis the survey results and can decide if and with whom to share the results with via an email “share” functionality. However, in a preferred embodiment, the results of the survey are always restricted to only go to the client unless the client later chooses to share those results.

The client may also receive custom behavioral reminders from the system in between coaching sessions and continue to receive them long after the formal coaching engagement ends.

Using the system, each client and his or her coach may put together a development plan highlighting two to three developmental objectives to work on in the coaching for the next several months. The executive coaching system may provide a convenient, non-intrusive way for the client to get “real-time” feedback on his or her progress against these objectives from a group of raters during, and beyond, the coaching. Additionally, the executive coaching system may also help rewire the client's neural pathways with regular behavioral reminders that appear on the user's mobile device, such as a tablet or smartphone. These reminders may be crafted by the client and coach and are specific to the client's unique developmental goals.

In a preferred embodiment, it is contemplated that the system may be provided, not as a retail product, but rather directly from an executive coach to his or her client. Accordingly, the system may be designed to be used by executives receiving coaching by a professional executive coach. Inputs into the user's profile are created in partnership between the client and his or her coach. These inputs may include: (i) the developmental objectives (for example, up to three objectives at a time); (ii) the related behavioral reminders (in an embodiment, one for each developmental objective); and (iii) the related feedback statements (in an embodiment, one for each developmental objective) to be sent to the client's raters.

The following is an example of how the system works in a preferred embodiment. As part of the user profile creation step, a user loads one behavioral reminder and one feedback statement for each of up to three developmental objectives into the application. The user then loads the email addresses for each of the raters. The system contacts the client with behavioral reminders at times and frequencies set by the user. The system then automatically emails the feedback statements to the raters at a frequency set by the user. Alternatively, the user can manually send out feedback statements whenever he or she wants. The raters then rate the user vis-à-vis the feedback statement. For example, the rating may be made on a scale of 1 to 10. The results from the raters may be shared on a restricted basis. For example, the system default may be for the results to be provided only to the user. However, there may be benefits to sharing the feedback results to a larger number of users, so the system may enable the user to select additional users with whom to share the results. For example, a share function may allow a user to send the results to a boss, a coach, etc., at the user's discretion. The feedback data may be stored, aggregated, categorized, and viewed using various filters, such as ratings over specified time periods, comparisons or rating between time periods, ratings by category of rater (e.g., bosses, peers, reports, etc.). Similarly, the coach or coaches may access the feedback data and evaluate the aggregated results by organization or department, for example, to assess the effectiveness of coaching in the business.

In one example, a method of providing real-time, ongoing, measurement of the results of executive coaching includes the steps of: providing a user interface through which a user identifies two or more developmental objectives, each developmental objective being associated with a behavioral reminder and a feedback statement; through the user interface, setting a reminder frequency to receive a notification of the behavioral reminder; through the user interface, receiving the behavioral reminder at the set reminder frequency; through the user interface, designating one or more reviewers to provide feedback regarding the developmental objectives; through the user interface, setting a feedback request frequency to provide an automated feedback request to the one or more reviewers; requesting feedback from the one or more reviewers at the set feedback request frequency using the feedback statement; and through the user interface, viewing the feedback from the one or more reviewers. Each of the behavioral reminders and the feedback statements may be a single sentence. Each of the instances of feedback from the one or more reviewers may include a qualitative component and quantitative component and the quantitative component may be a numerical score between 1 and 10. The step of viewing the feedback from the one or more reviewers may include viewing cumulative feedback scores over time. The step of viewing the feedback from the one or more reviewers may further include comparing the cumulative feedback scores to a self-assessed score. The step of viewing the feedback from the one or more reviewers may include viewing feedback from the one or more reviewers in real-time. Additionally, the method may further include a step of manually requesting feedback from the one or more reviewers at a time other than the set feedback request frequency.

An object of the invention is to evaluate the effectiveness of executive coaching by measuring tangible, observed improvement in client leadership effectiveness through ongoing feedback ratings from people who observe the client over time. This type of ongoing, real-time measurement has always been missing from executive coaching.

Another object of the invention is to provide client with direct control over the feedback process and allow them to see how they are progressing over time.

A further object of the invention is to provide “real time” feedback directly to the client, rather than have them wait for a coach to present the findings to them.

Yet another object of the invention is to keep development alive after the coaching is completed by allowing the client to continue to collect feedback and by providing regular behavioral reminders to the client for a period of time determined by the client, not by the length of the coaching engagement.

Another object of the invention is to provide aggregate data on progress against leadership developmental gaps and effectiveness of coaching programs to an entire division or company using executive coaching.

An advantage of the invention is that it helps rewire neural pathways leading to lasting behavioral change by coaching the client with regular behavioral reminders.

Another advantage of the invention is that it collects feedback from client's colleagues, etc. with a touch of a button and charts executive's progress over time against personal development goals.

A further advantage of the invention is that it keeps focus on development goals in between coaching sessions and long after the coaching engagement is over.

Yet another advantage of the invention is that over time it quantifies effectiveness of coaching for entire organization by providing aggregate measurement of progress against goals for all coaching clients.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of a system for providing real-time, ongoing, measurement of the results of executive coaching.

FIG. 2 is a schematic representation of a mobile device used in the system shown in FIG. 1.

FIG. 3 is a screen shot of a user interface of an example of a developmental objective used in the system shown in FIG. 1.

FIG. 4 is another screen shot of a user interface of an example of a developmental objective used in the system shown in FIG. 1.

FIG. 5 is another screen shot of a user interface of an example of a developmental objective used in the system shown in FIG. 1.

FIG. 6 is a screen shot of a user interface of an example of a settings control subsystem used in the system shown in FIG. 1.

FIG. 7 is a screen shot of a user interface of an example of a feedback request subsystem used in the system shown in FIG. 1.

FIG. 8 is a screen shot of a user interface of an example of a feedback submission form used in the system shown in FIG. 1.

FIG. 9 is a screen shot of a user interface of an example of a feedback presentation form used in the system shown in FIG. 1.

FIG. 10 is a screen shot of a user interface of an example of another feedback presentation form used in the system shown in FIG. 1.

FIG. 11 is a screen shot of a user interface of an example of behavioral reminders used in the system shown in FIG. 1.

### DETAILED DESCRIPTION OF THE INVENTION

The present disclosure provides an executive coaching system for real-time, ongoing measurement of the executive's progress against custom developmental goals using repeated feedback from co-workers who witness the client at work, and for providing frequent, regular behavioral reminders to continuously reform habits and behaviors.

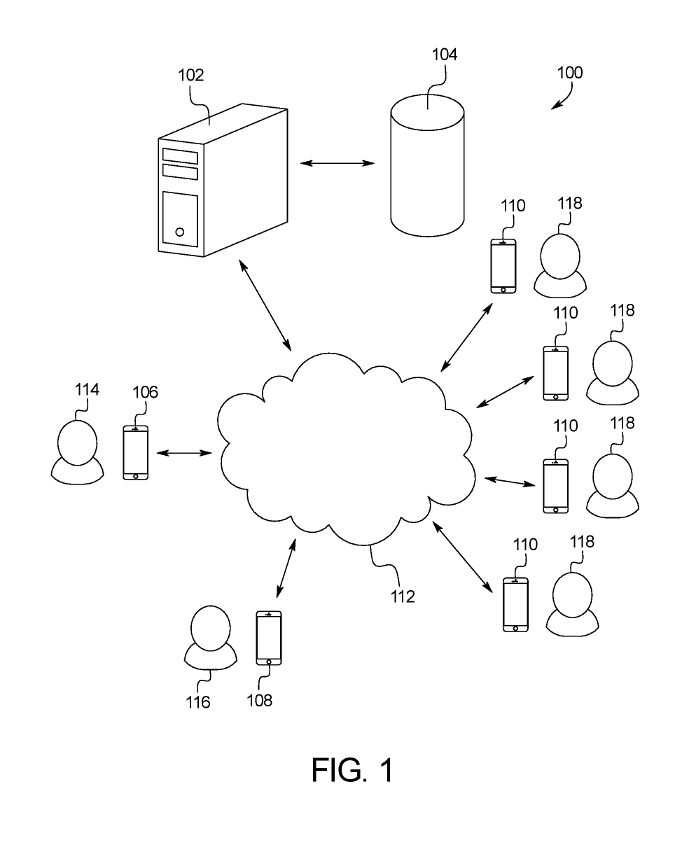

FIG. 1 illustrates a system for providing real-time, ongoing, measurement of the results of executive coaching comprising 100 (system 100). As shown in FIG. 1, the system includes a server 102 in communication with a database 104. The server 102 is in communication with a client device 106, a coach device 108, and a plurality of reviewer devices 110, through one or more communication networks 112, such as, the internet. As shown, the client device 106 is associated with a client 114, the coach device 108 is associated with a coach 116, and the reviewer devices 110 are associated with reviewers 118.

Aspects of the systems and methods described herein are controlled by one or more controllers. The server 102 in FIG. 1 is an example of a controller. The one or more controllers may be adapted run a variety of application programs, access and store data, including accessing and storing data in associated databases 104, and enable one or more interactions via the devices 106, 108, and 110. Typically, the one or more controllers are implemented by one or more programmable data processing devices. The hardware elements, operating systems, and programming languages of such devices are conventional in nature, and it is presumed that those skilled in the art are adequately familiar therewith.

For example, the one or more controllers may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory stores at least portions of instructions for execution by the CPU and data for processing in accord with the executed instructions.

The one or more controllers may also include one or more input/output interfaces for communications with one or more processing systems. The one or more such interfaces may include a network interface to enable communications via a network 112, e.g., to enable sending and receiving instructions electronically. The communication links may be wired or wireless.

The one or more controllers may further include appropriate input/output ports for interconnection with one or more output displays (e.g., monitors, printers, touchscreen, motion-sensing input device, etc.) and one or more input mechanisms (e.g., keyboard, mouse, voice, touch, bioelectric devices, magnetic reader, RFID reader, barcode reader, touchscreen, motion-sensing input device, etc.) serving as one or more user interfaces for the controller. For example, the one or more controllers may include a graphics subsystem to drive the output display. The links of the peripherals to the system may be wired connections or use wireless communications.

Those skilled in the art will recognize that the one or more controllers encompasses systems such as host computers, servers, workstations, network terminals, and the like. Further one or more controllers may be embodied in a mobile device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

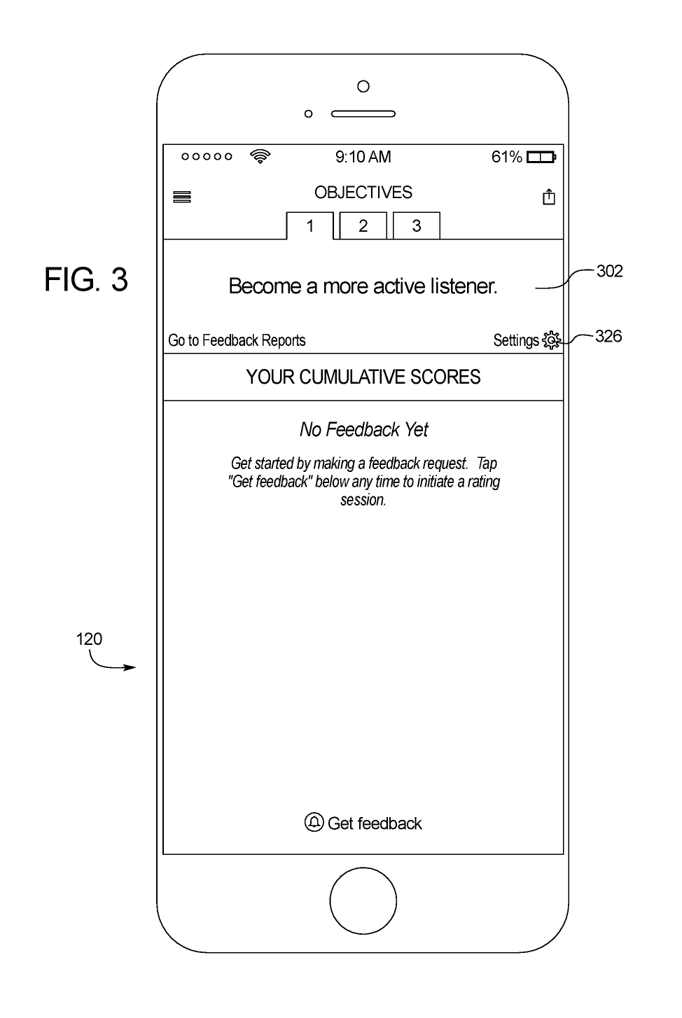

The client device 106, coach device 108, and plurality of reviewer devices 110 shown in FIG. 1 are mobile devices, such as smartphones or tablet computers. However, it is understood that any one or more of the client device 106, the coach device 108, and the plurality of reviewer devices 110 may be any other type of computing device capable of providing the user interface 120 required to provide the features and functions described herein. The user interface 120 and its various features and functions are described herein with respect to FIGS. 3-11.

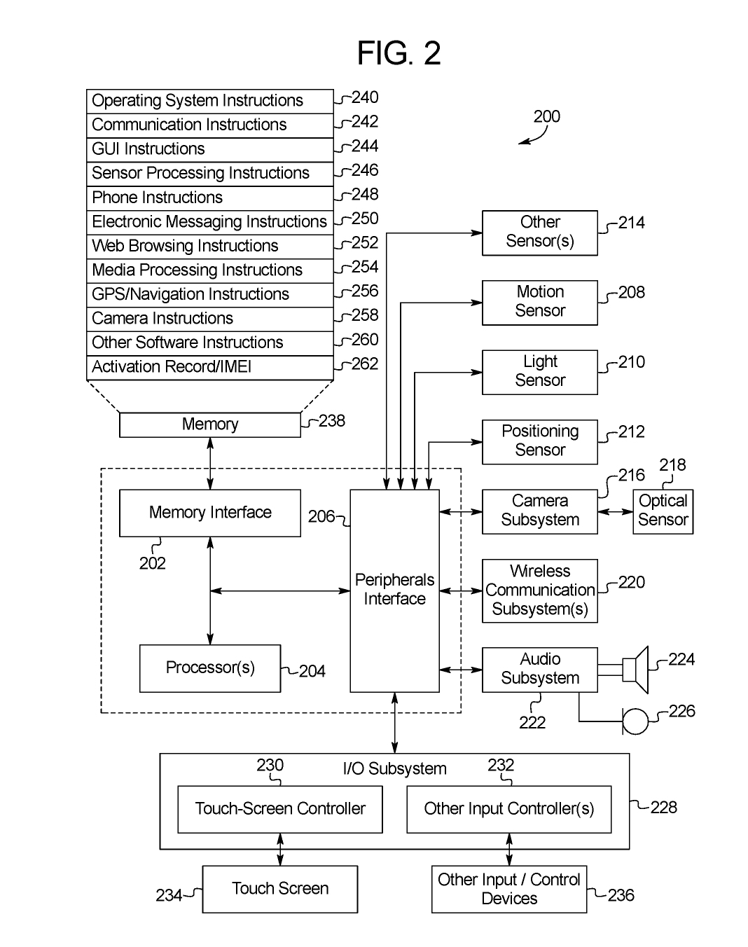

An example of a mobile device 200 is shown in FIG. 2. The mobile device 200 shown in FIG. 2 may be used as any one or more of the client device 106, the coach device 108, and the plurality of reviewer devices 110. As shown in FIG. 2, the mobile device 200 includes a memory interface 202, one or more data processors, image processors and/or central processors 204, and a peripherals interface 206. The memory interface 202, the one or more processors 204 and/or the peripherals interface 206 can be separate components or can be integrated in one or more integrated circuits. The various components in the mobile device 200 can be coupled by one or more communication buses or signal lines, as will be recognized by those skilled in the art.

Sensors, devices, and additional subsystems can be coupled to the peripherals interface 206 to facilitate various functionalities. For example, a motion sensor 208 (e.g., a gyroscope), a light sensor 210, and a positioning sensor 212 (e.g., GPS receiver) can be coupled to the peripherals interface 206 to facilitate the orientation, lighting, and positioning functions described further herein. Other sensors 214 can also be connected to the peripherals interface 206, such as a proximity sensor, a temperature sensor, a biometric sensor, or other sensing device, to facilitate related functionalities.

A camera subsystem 216 and an optical sensor 218 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 220, which can include radio frequency receivers and transmitters and/or optical (e.g., infrared) receivers and transmitters. The specific design and implementation of the communication subsystem 220 can depend on the communication network(s) over which the mobile device 200 is intended to operate. For example, the mobile device 200 can include communication subsystems 220 designed to operate over a GSM network, a GPRS network, an EDGE network, a UMTS network, an HSPA network, an LTE network, a Wi-Fi or WiMax network, and a Bluetooth™ network. In particular, the wireless communication subsystems 220 may include hosting protocols such that the mobile device 200 may be configured as a base station for other wireless devices.

An audio subsystem 222 can be coupled to a speaker 224 and a microphone 226 to facilitate voice-enabled functions, such as voice recognition, voice replication, digital recording, and telephony functions.

The I/O subsystem 228 can include a touch screen controller 230 and/or other input controller(s) 232. The touch-screen controller 230 can be coupled to a touch screen 234. The touch screen 234 and touch screen controller 230 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 234. The other input controller(s) 232 can be coupled to other input/control devices 236, such as one or more buttons, rocker switches, thumb-wheel, infrared port, USB port, and/or a pointer device such as a stylus. The one or more buttons (not shown) can include an up/down button for volume control of the speaker 224 and/or the microphone 226.

The memory interface 202 can be coupled to memory 238. The memory 238 can include high-speed random access memory and/or non-volatile memory, such as one or more magnetic disk storage devices, one or more optical storage devices, and/or flash memory (e.g., NAND, NOR). The memory 238 can store operating system instructions 240, such as Darwin, RTXC, LINUX, UNIX, OS X, iOS, WINDOWS, or an embedded operating system such as VxWorks. The operating system instructions 240 may include instructions for handling basic system services and for performing hardware dependent tasks. In some implementations, the operating system instructions 240 can be a kernel (e.g., UNIX kernel).

The memory 238 may also store communication instructions 242 to facilitate communicating with one or more additional devices, one or more computers and/or one or more servers. The memory 238 may include graphical user interface instructions 244 to facilitate graphic user interface processing; sensor processing instructions 246 to facilitate sensor-related processing and functions; phone instructions 248 to facilitate phone-related processes and functions; electronic messaging instructions 250 to facilitate electronic-messaging related processes and functions; web browsing instructions 252 to facilitate web browsing-related processes and functions; media processing instructions 254 to facilitate media processing-related processes and functions; GPS/Navigation instructions 256 to facilitate GPS and navigation-related processes and instructions; camera instructions 258 to facilitate camera-related processes and functions; and/or other software instructions 260 to facilitate other processes and functions (e.g., access control management functions, etc.). The memory 238 may also store other software instructions (not shown) controlling other processes and functions of the mobile device 200 as will be recognized by those skilled in the art. In some implementations, the media processing instructions 254 are divided into audio processing instructions and video processing instructions to facilitate audio processing-related processes and functions and video processing-related processes and functions, respectively. An activation record and International Mobile Equipment Identity (IMEI) 262 or similar hardware identifier can also be stored in memory 238.

Each of the above identified instructions and applications can correspond to a set of instructions for performing one or more functions described herein. These instructions need not be implemented as separate software programs, procedures, or modules. The memory 238 can include additional instructions or fewer instructions. Furthermore, various functions of the mobile device 200 may be implemented in hardware and/or in software, including in one or more signal processing and/or application specific integrated circuits.

In one example, the memory 238 includes stored instructions that, when executed by the processor 204, cause it to perform the steps of the methods described herein, including providing the user interface 120 and its various features and functions are described herein with respect to FIGS. 3-11. As shown, the features and functions provide systems and methods of providing real-time, ongoing, measurement of the results of executive coaching including: providing a user interface 120 through which a user identifies two or more developmental objectives 302, each developmental objective 302 being associated with a behavioral reminder 304 and a feedback statement 306; through the user interface 120, setting a reminder frequency 308 to receive a notification 310 of the behavioral reminder 304; through the user interface 120, receiving the behavioral reminder 304 at the set reminder frequency; through the user interface 120, designating one or more reviewers 118 to provide feedback regarding the developmental objectives 302; through the user interface 120, setting a feedback request frequency 312 to provide an automated feedback request 314 to the one or more reviewers 118; requesting feedback 316 from the one or more reviewers 118 at the set feedback request frequency 312 using the feedback statement 306; and through the user interface 120, viewing the feedback 316 from the one or more reviewers 118. Each of the behavioral reminders 304 and the feedback statements 306 may be a single sentence. Each of the instances of feedback 316 from the one or more reviewers 118 may include a qualitative component 318 and quantitative component 320 and the quantitative component 320 may be a numerical score between 1 and 10. The step of viewing the feedback 316 from the one or more reviewers 118 may include viewing cumulative feedback scores 322 over time. The step of viewing the feedback 316 from the one or more reviewers 118 may further include comparing the cumulative feedback scores 322 to a self-assessed score 324. The step of viewing the feedback 316 from the one or more reviewers 118 may include viewing feedback 316 from the one or more reviewers 118 in real-time. Additionally, the method may further include a step of manually requesting feedback 316 from the one or more reviewers 118 at a time other than the set feedback request frequency 312.

As shown in FIGS. 3-11, the user interface 120 may be an interactive interface provided through one or more of the client device 106, the coach device 108, and the plurality of reviewer devices 110. Turning now to FIG. 3, the user interface 120 displays an example of a developmental objective 302. In the example shown in FIG. 3, the developmental objective is “Become a more active listener.” Depending on the context in which the system 100 is used, the developmental objective 302 may be input to the system 100 through the user interface 120 by the client 114, the coach 116, or even the reviewers 118. In the preferred embodiment described herein, the developmental objective 302 is input by the coach 116 through the coach device 108, stored by the server 102 in the database 104 to be accessible by the client 114 through the client device 106.

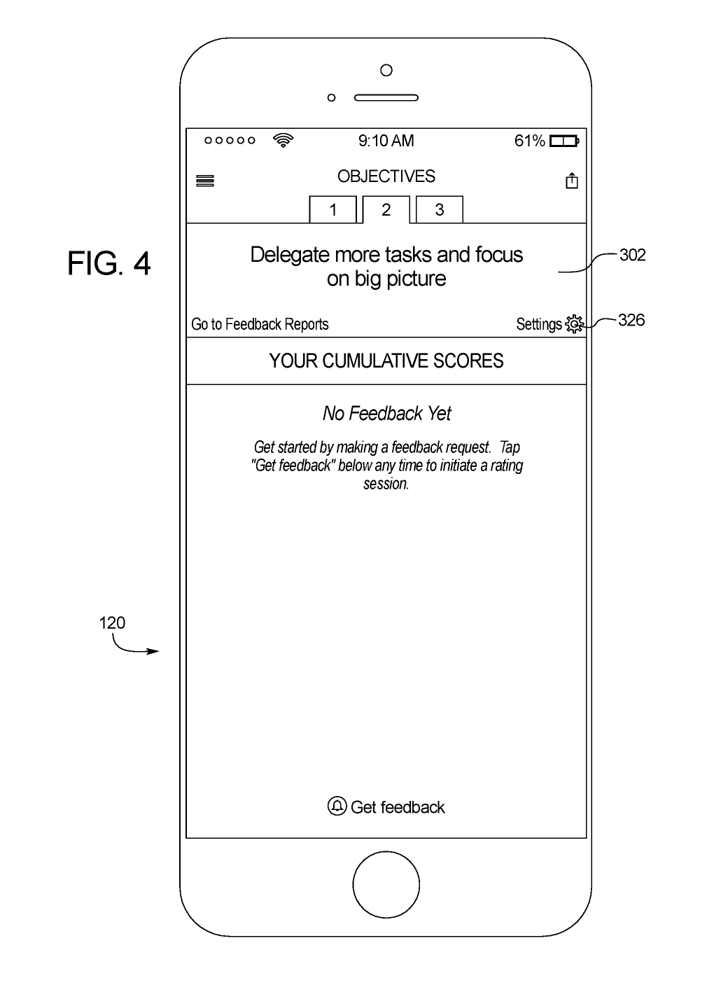

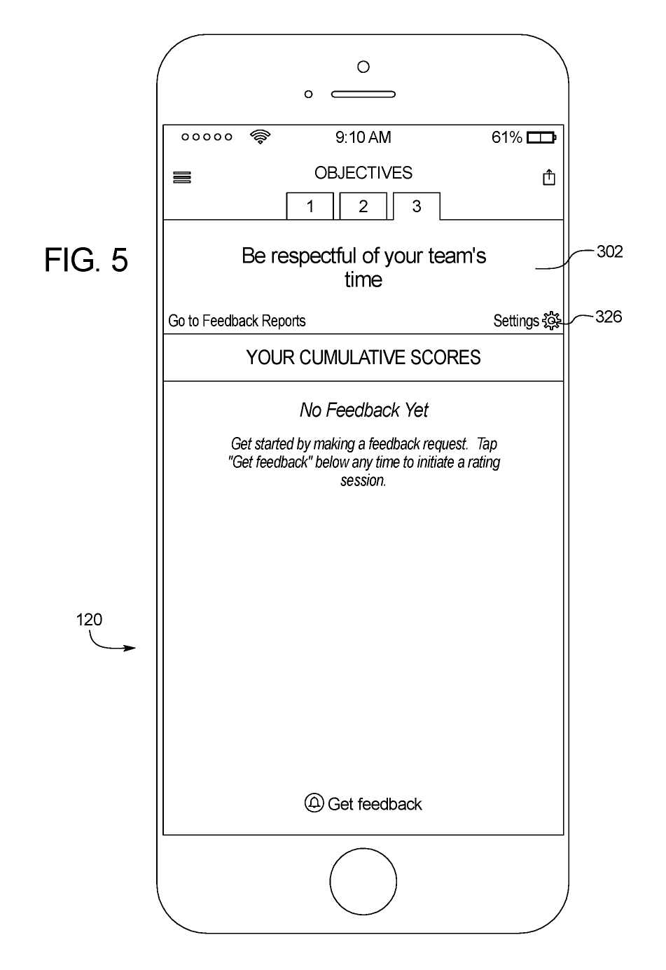

FIGS. 4 and 5 illustrate a second and a third developmental objective 302, respectively. In FIG. 4, the developmental objective 302 is “Delegate more tasks and focus on big picture” and in FIG. 5, the developmental objective 302 is “Be respectful of your team's time.” In the preferred embodiment, the coach 116 inputs two or three developmental objectives 302 to be used by the client 114. As described further herein, for each developmental objective 302, the coach 116 may further create a one-sentence behavioral reminder 304 and a one-sentence feedback statement 306.

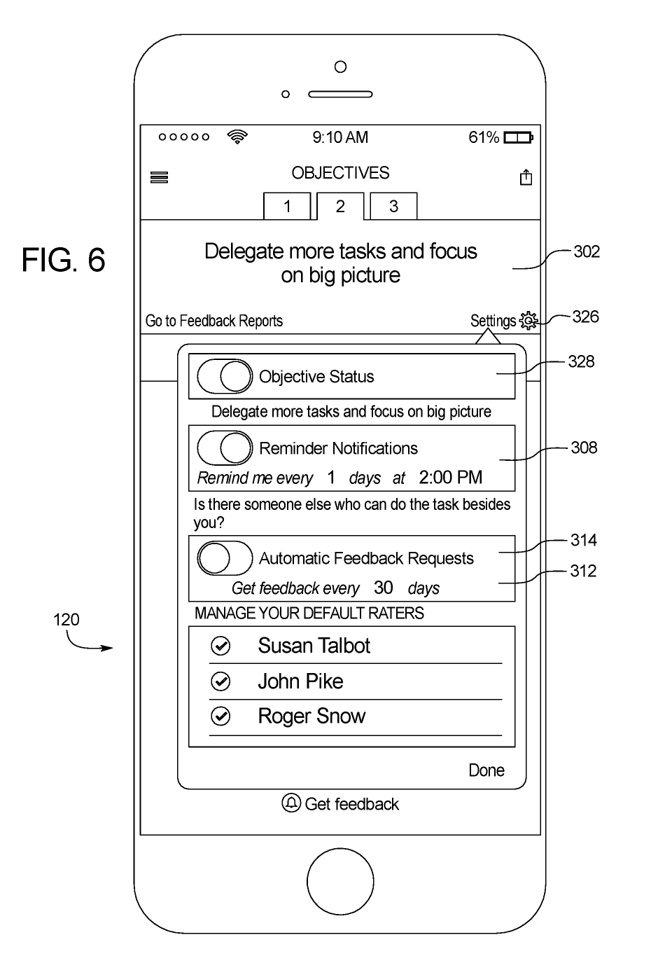

Turning to FIG. 6, the user interface 120 is shown to provide setting controls 326 for: toggling on and off the selected developmental objective 302 to which the setting controls 326 apply; setting a reminder frequency 308 to receive a notification 310 of the behavioral reminder 304 related to the developmental objective 302; designating one or more reviewers 118 to provide feedback regarding the developmental objective 302; and setting a feedback request frequency 312 to provide an automated feedback request 314 to the one or more reviewers 118. In the example shown in FIG. 6, the objective status control 328 is set to the “on” position, the reminder frequency 308 is set to remind the client 114 of the developmental objective 302 using the behavioral reminder 304 every day at 2:00 PM, the feedback request frequency 312 is set to 30 days, and three reviewers 118 (i.e., Susan Talbot, John Pike, and Roger Snow) have been selected to provide feedback 316. In addition, there is a “Get Feedback” selection 328 that enables the client 114 to manually request feedback 316 from the reviewers 118 outside of the scheduled feedback request frequency 312.

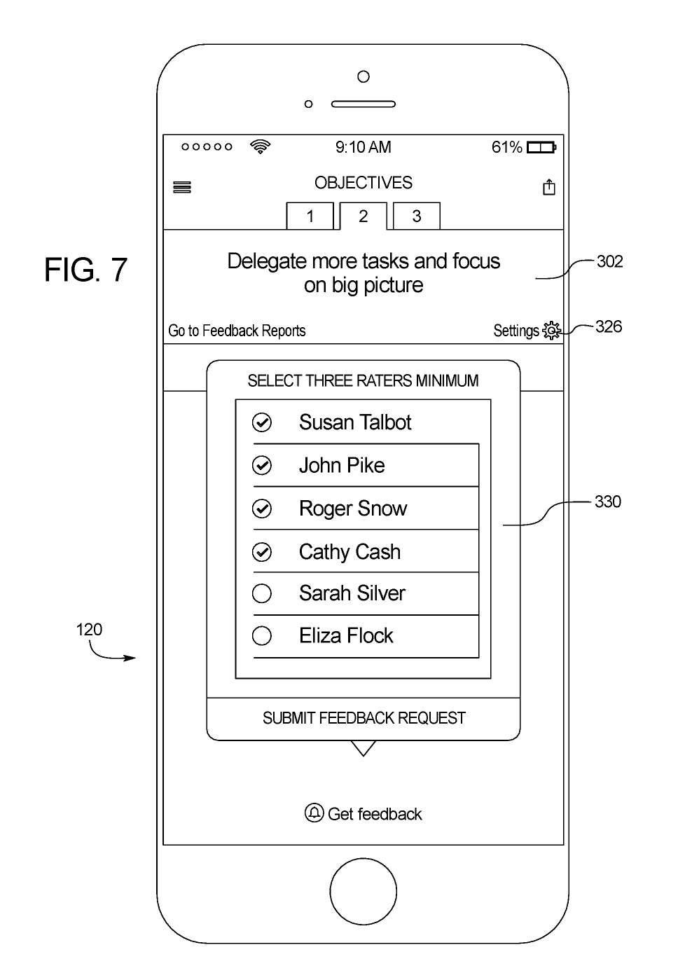

FIG. 7 illustrates additional context for the reviewer selection controls 330. As shown, the reviewer selection controls 330 enable the client 114 to toggle various reviewers 118 between a selected and deselected option. The reviewer selection controls 330 shown in FIG. 7 may be provided through the user interface 120 and used specifically when manually requesting feedback 316.

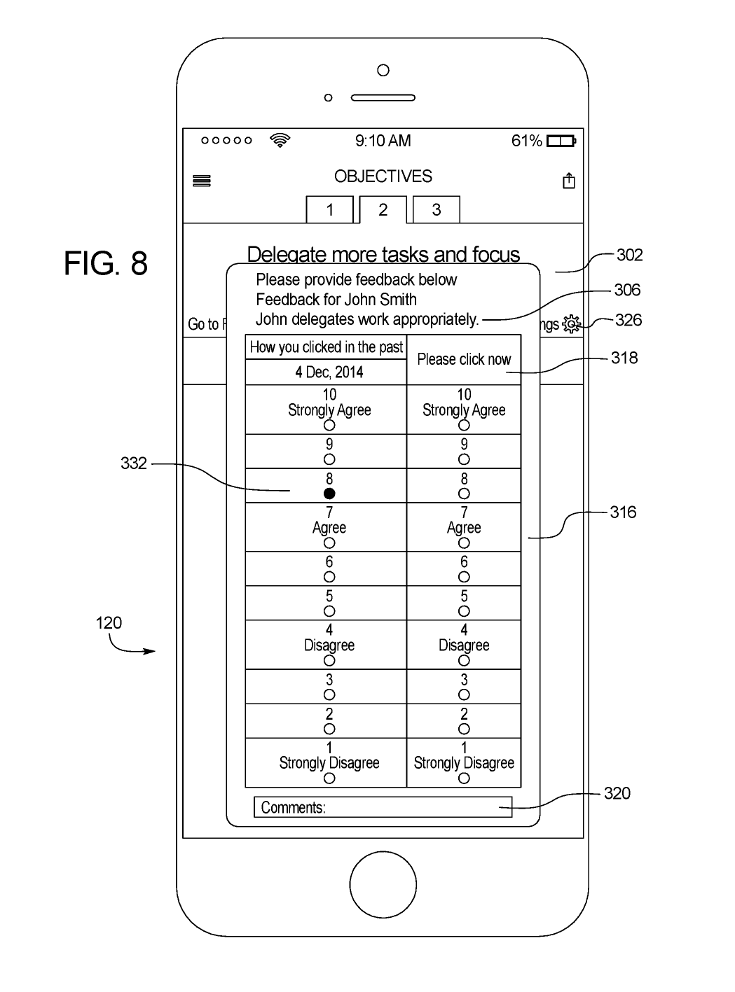

FIG. 8 is an example of the user interface 120 illustrating the feedback request 314 (manual or automated) provided to the one or more reviewers 118. As shown in FIG. 8, the reviewer 118 is presented with the feedback request 314 wherein the reviewer 118 is asked to rate the client 114 with respect to the feedback statement 306 (e.g., John delegates work properly) on a ten-point scale. In the example shown in FIG. 8, if the reviewer 118 has provided the client 114 a previous rating 332 with respect to the feedback statement 306, the previous rating 332 is provided alongside the feedback request 314. As shown the feedback request 314 includes qualitative component 318 (e.g., comments section) and quantitative component 320 (e.g., numerical rating).

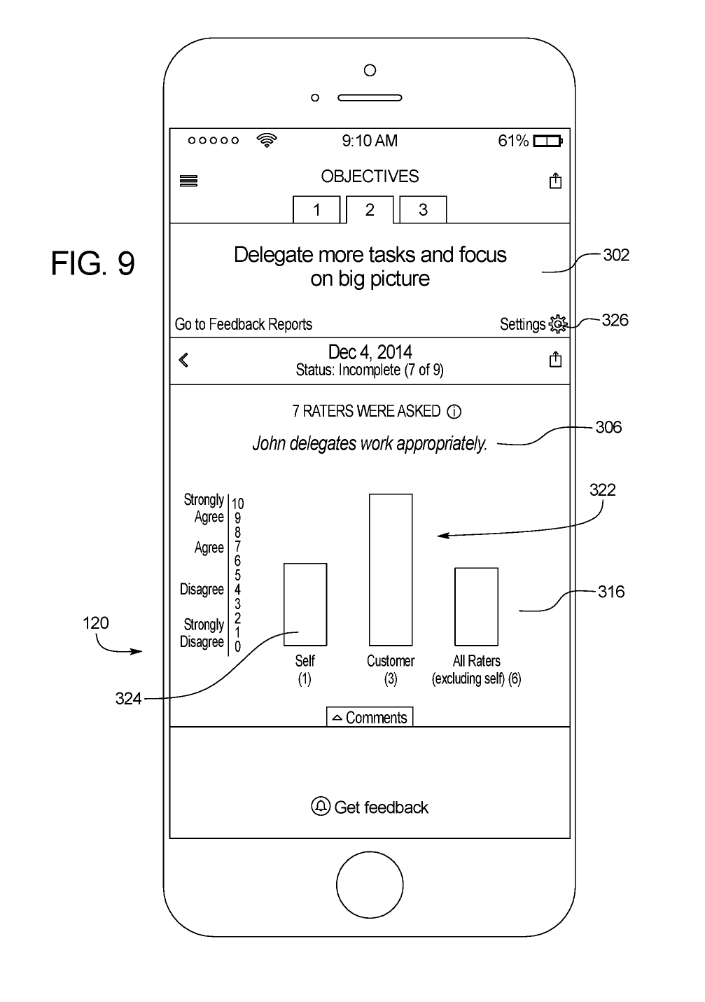

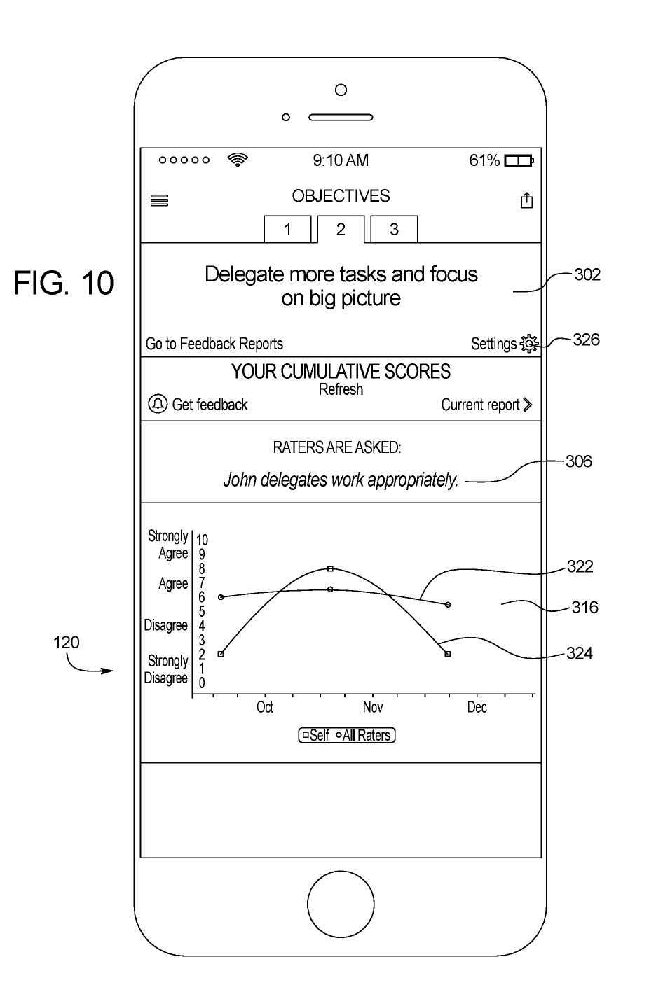

As raters respond to the feedback request 314, the client 114 can view the feedback 316 through the user interface 120 on the client device 106. In the example shown in FIG. 9, the feedback 316 is broken out by type of rater 118 (e.g., self, customer, all raters 118). In FIG. 10, the feedback 316 is shown over a period of time such that the client 114 can evaluate his or her progress over time.

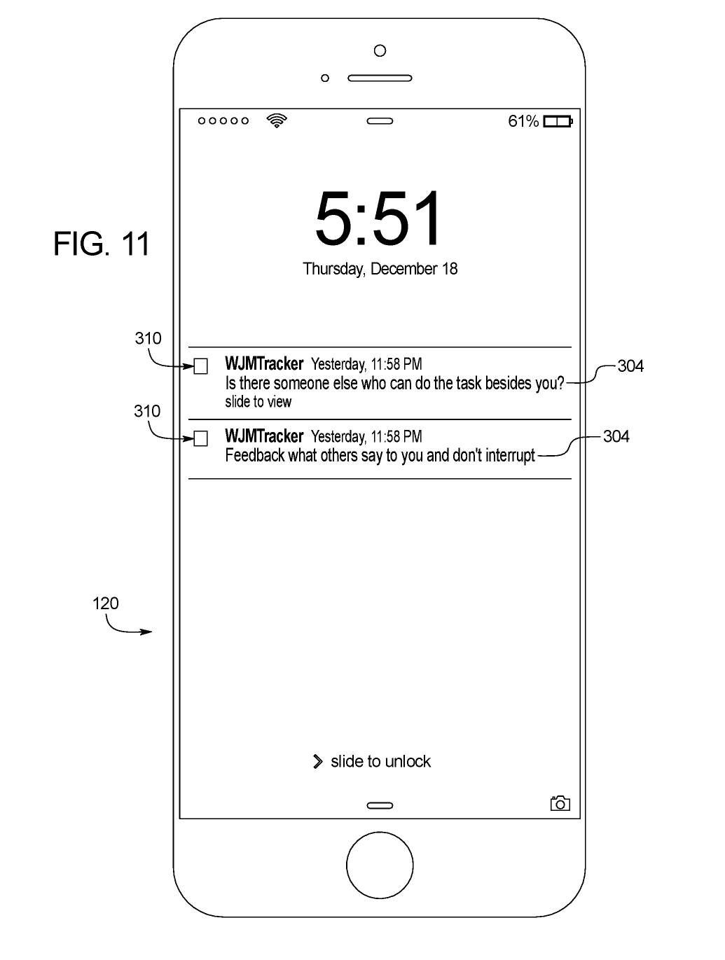

FIG. 11 is an example of the client 114 receiving a notification 310 of the behavioral reminders 304 through the user interface 120. In the example shown, the behavioral reminders 304 are “Is there someone else who can do the task besides you?” and “Feedback what others say to you and don't interrupt.” These behavioral reminders 304 may be provided through the user interface 120 at a set reminder frequency 308.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method of providing real-time, ongoing, measurement of the results of executive coaching comprising the steps of:
providing a user interface through which a user identifies two or more developmental objectives, each developmental objective being associated with a behavioral reminder and a feedback statement;
through the user interface, setting a reminder frequency to receive a notification of the behavioral reminder;
through the user interface, receiving the behavioral reminder at the set reminder frequency;
through the user interface, designating one or more reviewers to provide feedback regarding the developmental objectives;
through the user interface, setting a feedback request frequency to provide an automated feedback request to the one or more reviewers;
requesting feedback from the one or more reviewers at the set feedback request frequency using the feedback statement; and
through the user interface, viewing the feedback from the one or more reviewers.

2. The method of claim 1 wherein each behavioral reminder is a single sentence.

3. The method of claim 1 wherein each feedback statement is a single sentence.

4. The method of claim 3 wherein each of the instances of feedback from the one or more reviewers includes a qualitative component and quantitative component.

5. The method of claim 4 wherein the quantitative component is a numerical score between 1 and 10.

6. The method of claim 1 wherein the step of viewing the feedback from the one or more reviewers includes viewing cumulative feedback scores over time.

7. The method of claim 6 wherein the step of viewing the feedback from the one or more reviewers includes comparing the cumulative feedback scores to a self-assessed score.

8. The method of claim 1 wherein the step of viewing the feedback from the one or more reviewers includes viewing feedback from the one or more reviewers in real-time.

9. The method of claim 1 further comprising the step of manually requesting feedback from the one or more reviewers at a time other than the set feedback request frequency.

10. A system for providing real-time, ongoing, measurement of the results of executive coaching comprising:
a controller;
a display associated with the controller; and
memory associated with the controller, the memory storing instructions that, when loaded into the controller, cause the controller to perform the following steps:
providing a user interface on the display through which a user identifies two or more developmental objectives, each developmental objective being associated with a behavioral reminder and a feedback statement;
through the user interface, setting a reminder frequency to receive a notification of the behavioral reminder;
through the user interface, receiving the behavioral reminder at the set reminder frequency;
through the user interface, designating one or more reviewers to provide feedback regarding the developmental objectives;
through the user interface, setting a feedback request frequency to provide an automated feedback request to the one or more reviewers;
requesting feedback from the one or more reviewers at the set feedback request frequency using the feedback statement; and
through the user interface, viewing the feedback from the one or more reviewers.

11. The system of claim 10 wherein each behavioral reminder is a single sentence.

12. The system of claim 10 wherein each feedback statement is a single sentence.

13. The system of claim 12 wherein each of the instances of feedback from the one or more reviewers includes a qualitative component and quantitative component.

14. The system of claim 13 wherein the quantitative component is a numerical score between 1 and 10.

15. The system of claim 10 wherein the step of viewing the feedback from the one or more reviewers includes viewing cumulative feedback scores over time.

16. The system of claim 15 wherein the step of viewing the feedback from the one or more reviewers includes comparing the cumulative feedback scores to a self-assessed score.

17. The system of claim 10 wherein the step of viewing the feedback from the one or more reviewers includes viewing feedback from the one or more reviewers in real-time.

18. The system of claim 10 further comprising the step of manually requesting feedback from the one or more reviewers at a time other than the set feedback request frequency.
